(19) United States
(12) Patent Application Publication
(10) Pub. No.: US 2026/0092841 A1
(43) Pub. Date: Apr. 2, 2026

(54) A MICROFLUIDIC CARTRIDGE FOR ENRICHING A BIOLOGICAL FLUID

(71) Applicant: SIGTUPLE TECHNOLOGIES PRIVATE LIMITED, Karnataka (IN)

(72) Inventors: Srinivasan Kandaswamy, Bengaluru (IN); Avinash Sahu, Bengaluru (IN); Venkata Anil Kumar Modali, Bengaluru (CN)

(21) Appl. No.: 19/114,768

(22) PCT Filed: Sep. 26, 2023
(86) PCT No.: PCT/IB2023/059484

§ 371 Date: Mar. 24, 2025

(30) Foreign Application Priority Data
Sep. 26, 2022 (IN) 202243054938

(51) Int. Cl. G01N 1/38

(52) U.S. Cl. CPC G01N 1/38; G01N 2001/382

(57) ABSTRACT

The present disclosure discloses a microfluidic cartridge (100) for enriching a biological fluid of low viscosity. The cartridge (100) includes a base plate (1) and a coverslip (5) positioned above the base plate (1), to define a chamber (2) for receiving the biological fluid containing a plurality of particles (10), where the chamber (2) is defined with a predefined height. An inlet section (3a) is defined at one end (4a) of the chamber (2) for introducing the biological fluid and an outlet section (3b) is defined at another end (4b) opposite to the one end. The plurality of particles (10) is enriched about the predefined height of the chamber (2), under action of gravity over a predefined time. The configuration of the cartridge (100) enables formation of monolayer and uniform distribution of the plurality of particles in the biological fluid.

### TECHNICAL FIELD

Present disclosure relates in general to the field of biomedical sciences. Particularly, but not exclusively, the present disclosure relates to devices used for microscopic examination of biological fluids. Further, embodiments of the present disclosure disclose a microfluidic cartridge for enriching a biological fluid having low viscosity.

### BACKGROUND OF DISCLOSURE

Generally, biological fluids, including, but not limited to, urine and/or other biological fluids having low viscosity and/or surface tension are analyzed under a microscope. The analysis may be performed for acquiring various information such as, but not limited to, cytology, cell concentration, cell motility, morphological features, and the like. For such analysis, the biological fluid may be deposited on a microscopic slide and may be suitably prepared either manually by an operator or automatically by automated devices. Further, analysis of the biological fluid may be performed under stained or unstained conditions of the biological fluid, or may be subjected to bio-chemical reagents for chemically analyzing the biological fluid.

Conventionally, in order to analyze the biological fluid under the microscope, such biological fluids may be smeared on the microscopic slide. The smearing of the biological fluid may be performed either manually or automatically by employing various methods and apparatuses. In order to carry out smearing of the biological fluid, a droplet of the biological fluid may be dropped proximal to one end of the microscopic slide and, such droplet may be spread across the microscopic slide by a first sweeping member, coupled to a mechanism or operated by a medical practitioner. However, such conventional methods of smearing may often lead to defects including, but not limited to, inconsistent thickness of the biological fluid at a smeared region, cell damage, uneven distribution of cells, and the like. Due to these defects, factors such as, but not limited to, field of view, scan area, and the like, may be affected, thereby rendering deviation in accuracy of the analysis. In addition, the smearing process may be tedious and may generally be dependent on skill of the medical practitioner or accuracy of the mechanism to produce proper smeared biological fluid.

Also, with the advent of technology, efforts have been made to circumvent smearing of the biological fluid and develop other modes of preparing the biological fluids for analysis through the microscope. One of such developed methods may be by employing microfluidic cartridges, where the microfluidic cartridges may include a cavity to receive the biological fluid. However, such microfluidic cartridges may lack driving force to allow flow of the biological fluid and also may not allow settling of cells within the cavity, which may lead to clustering of cells of the biological fluid within the cavity, formation of void spaces in the cavity and the like, which may hinder scan region for analysis of the biological fluid through the microscope. Specifically, when the biological fluid has high viscosity, then conventional microfluidic cartridges are operated with additional components such as pumps and reservoirs/separators. The pumps are employed for continuously supplying the biological fluid into the conventional microfluidic cartridges, while the reservoirs are included to supplement the chamber of the conventional microfluidic cartridges for allowing settling of the cells therein. However, such configurations of the conventional microfluidic cartridges are bulky for handling and analysis, and are limited to high viscosity fluids, while being expensive in view of additional components for handling and operation of said cartridges.

Further, for biological fluids having low viscosity, for example urine, a wet mount method is employed for analysis. The wet mount method involves centrifugation and slide preparation. Initially, raw urine samples are centrifuged at a predefined rpm for a preset time to allow urine cells/particles to concentrate. After centrifugation, the supernatant is discarded and pellet (urine sediment) is recovered. A slide is then prepared for microscopic analysis by placing a coverslip over the urine sediment. This wet mount method requires a lot of time and labor, which becomes more significant when a large number of samples are to be processed. Apart from the requirement of time and labor, the wet mount method is associated with other disadvantages such as degradation of cells during centrifugation, drying of samples, bubbles formation and drift of cells/particles, which are undesired.

The present disclosure is directed to overcome one or more limitations stated above.

### SUMMARY OF THE DISCLOSURE

One or more shortcomings of the conventional system or method of preparing biological fluid for analysis are overcome and additional advantages are provided through the microfluidic cartridge as claimed in the present disclosure. Additional features and advantages are realized through the techniques of the present disclosure. Other embodiments and aspects of the disclosure are described in detail herein and are considered a part of the claimed disclosure.

In a non-limiting embodiment of the present disclosure, a microfluidic cartridge for enriching a biological fluid of low viscosity is disclosed. The cartridge includes a base plate which may define a flow surface. Further, the cartridge includes a coverslip which is positioned above the base plate, to define a chamber on the flow surface of the base plate for receiving the biological fluid containing a plurality of particles. The coverslip is configured to conceal at least a portion of the chamber, such that the chamber is defined with a predefined height. Additionally, the cartridge includes an inlet section that is defined at one end of the chamber for introducing the biological fluid and an outlet section at another end opposite to the one end of the chamber. The inlet section and the outlet section are adapted to extend beyond the coverslip, to draw the biological fluid under capillary action. Furthermore, the plurality of particles of the biological fluid is enriched about the predefined height of the chamber, under action of gravity over a predefined time. Such configuration of the cartridge enables distribution of the plurality of particles of the biological fluid for formation of monolayer. Also, due to such configuration of the microfluidic cartridge being capable of producing monolayer under action of gravity within the predefined height of the chamber, additional components such as pumps or reservoirs are avoided, thereby significantly reducing costs associated with manufacturing and handling.

In an embodiment, the biological fluid is urine.

In an embodiment, the predefined height of the chamber is at least two times the height of a group of large size particles in the plurality of particles in the biological fluid.

In an embodiment, the predefined height of the chamber ranges from about 150 μm to 400 μm.

In an embodiment, the plurality of particles of the biological fluid is enriched in the chamber under gravity sedimentation to form a monolayer of the biological fluid about the predefined height of the chamber.

In an embodiment, the monolayer defined by the plurality of particles of the biological fluid in the chamber includes a clumber region defined by a group of lower size particles in the plurality of particles. Further, the monolayer defined by the plurality of particles includes a focus region which is defined by a combination of a group of moderate size particles, the group of lower size particles, and a group of large size particles. Furthermore, the monolayer includes a sparse region which is defined by the group of the large size particles.

In an embodiment, the cartridge includes a spacer element which is positioned between the base plate and the coverslip. The spacer element is adapted to define the chamber, the inlet section and the outlet section.

In an embodiment, the predefined time ranges from about 1 min to 15 mins.

In an embodiment, volume of the biological fluid introduced into the chamber ranges from 0.06 ml to 0.8 ml. Further, viscosity of the biological fluid ranges from 0.5 cP to 2 cP.

In an embodiment, the cartridge includes a coating surface applied on the base plate and the coverslip, which is configured to stain the biological fluid.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings wherein like reference numerals represent like elements and in which:

FIG. 1 illustrates a schematic top view of a microfluidic cartridge, in accordance with an embodiment of the present disclosure.

FIG. 2 illustrates a side view of the microfluidic cartridge, in accordance with an embodiment of the present disclosure.

FIG. 3a illustrates a side view of the microfluidic cartridge introduced with a biological fluid, in accordance with an embodiment of the present disclosure.

FIG. 3b illustrates a side view of the microfluidic cartridge introduced with a biological fluid, in accordance with another embodiment of the present disclosure.

FIG. 4 illustrates a top view of a microfluidic cartridge assembly having a plurality of microfluidic cartridges, in accordance with an embodiment of the present disclosure.

The figures depict embodiments of the disclosure for purposes of illustration only. One skilled in the art will readily recognize from the following description that alternative embodiments of the cartridge and the assay illustrated herein may be employed without departing from the principles of the disclosure described herein.

### DETAILED DESCRIPTION

While the embodiments in the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is to cover all modifications, equivalents, and alternatives falling within the scope of the disclosure.

It is to be noted that a person skilled in the art would be motivated from the present disclosure and modify various features of the microfluidic cartridge, without departing from the scope of the disclosure. Therefore, such modifications are considered to be part of the disclosure. Accordingly, the drawings show only those specific details that are pertinent to understanding the embodiments of the present disclosure, so as not to obscure the disclosure with details that will be readily apparent to those of ordinary skill in the art having the benefit of the description herein. Also, the microfluidic cartridge of the present disclosure may be employed in analysis of various biological fluids including, but not limited to, urine and the like.

The terms “comprises”, “comprising”, or any other variations thereof used in the disclosure, are intended to cover a non-exclusive inclusion, such that the cartridge that comprises a list of components does not include only those components, but may include other components not expressly listed or inherent to such device or apparatus. In other words, one or more elements in the cartridge proceeded by “comprises . . . a” does not, without more constraints, preclude the existence of other elements or additional elements in the device.

Henceforth, the present disclosure is explained with the help of figures illustrating a microfluidic cartridge for enriching a biological fluid. However, such exemplary embodiments should not be construed as limitations of the present disclosure. A person skilled in the art can envisage various such embodiments without deviating from the scope of the present disclosure.

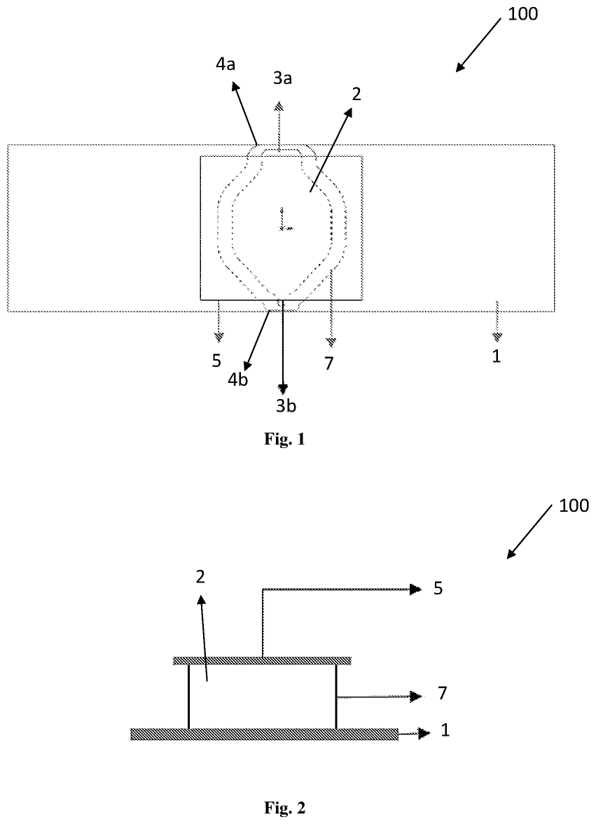

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-4.

FIGS. 1 and 2 are exemplary embodiments of the present disclosure, illustrating a top view and a side view, respectively, of a microfluidic cartridge (100). The microfluidic cartridge (100) [hereafter interchangeably referred to as “cartridge (100)”] may be configured to receive and contain a biological fluid having low viscosity, for performing various analyses under a microscope [not shown in Figures]. The cartridge (100) may be configured to receive the biological fluid in a defined manner, so as to initiate analysis of the biological fluid without requirement of further preparation such as, but not limited to, smearing, striking, collapsing, or other preparation on the cartridge (100) for receiving and/or settlement of the biological fluid thereto.

In an embodiment, the biological fluid may include a plurality of particles (10). The plurality of particles (10) may be including but not limited to cells, microorganisms, chemical compounds in the biological fluid, and the like, which may be capable of being viewed and/or analyzed under the microscope. The plurality of particles may be categorized based on various parameters including, but not limited to, dimension, chemical affinity, pH level, nativity with respect to the biological fluid, and the like, which may be capable of being distinguished under the microscope. In the illustrative embodiment, the plurality of particles are to be analyzed under the microscope in accordance with at least one of the above parameters, and for simplicity of explanation of the cartridge (100), the parameter is limited to dimension of each of the plurality of particles of the biological fluid. Such explanation may not be construed as a limitation of the present disclosure, while other parameters of the plurality of particles of the biological fluid may also be analyzed and/or processed in similar or substantially similar configuration described herein. Further, in the exemplary embodiment, the biological fluid may include, but not limited to, urine and any other biological fluid having low viscosity, for performing various analyses under a microscope [not shown in Figures]. In an embodiment, viscosity of the biological fluid may range from 0.5 cP to 2 cP, which may be received, processed and prepared in the cartridge (100) for said analysis. Additionally, in the exemplary embodiment, the plurality of particles of the biological fluid is categorized under dimension as being defined with lower size, moderate size and large size. In an embodiment, the plurality of particles may range from 1 μm to 75 μm.

In another embodiment, the biological fluid may have a low surface tension which may range from 3 mN/m to 12 mN/m, which may be received, processed and prepared in the cartridge (100) for said analysis.

The cartridge (100) includes a base plate (1), defined with a flow surface. The base plate (1) may be defined with a thickness, and the flow surface is defined on one of the parallel major surfaces of the base plate (1). The parallel major surface of the base plate (1) which defines the flow surface may be provided with a surface coating or may be polished to allow smooth flow [i.e., with minimal or without any turbulence] of the biological fluid thereon. The flow surface of the base plate (1) may be configured to receive and allow flow of fluids including, but not limited to, the biological fluids, staining agents for the biological fluid, wetting agents of the microscope and the like. In the illustrative embodiment, the flow surface of the base plate (1) may be defined at a top surface, which may be referred to a surface exposed to a lens of the microscope for analysis of the biological fluid, while such direction of the base plate (1) or the flow surface cannot be construed to be limiting as the same can be changed in view of change in direction of orientation of the cartridge (100) relative to the microscope.

Further, the cartridge (100) includes a coverslip (5) which may be positioned above the flow surface, and in-turn the top surface of the base plate (1). The coverslip (5) may be made of a transparent material including, but not limited to, glass, polymeric materials, and the like, for allowing analysis of the biological fluid on the flow surface, through the microscope. The coverslip (5) and the base plate (1) may define a chamber (2) on the flow surface such that, the biological fluid that flows on the base plate (1) may be received and accommodated in the chamber (2). The chamber (2) may either be integrally formed as a part of the base plate (1), or may be selectively constructed on the flow surface of the base plate (1). In an embodiment, the chamber (2) may be defined by transversely extending walls from the flow surface or may be etched in the flow surface to be integrally defined with the base plate (1). However, this transversely extending walls cannot be considered as a limitation, as the geometrical shape of the chamber (2) may vary based on the requirement. In the illustrative embodiment, the chamber (2) may be defined between the coverslip (5) and the base plate (1) by selectively positioning a spacer element (7) in a predefined pattern on the flow surface, as best seen in FIG. 2. The spacer element (7) may be a non-porous member having an adhesive surface on either side for affixing with the base plate (1) and the coverslip (5), respectively. The space element (7) may be selected such that, negligible or no quantity of the biological fluid is absorbed thereto, and defined quantity supplied to the chamber remains substantially constant for analysis under the microscope. Also, the spacer element (7) may be chemically neutral towards the biological fluid and the staining reagents employed for analysis.

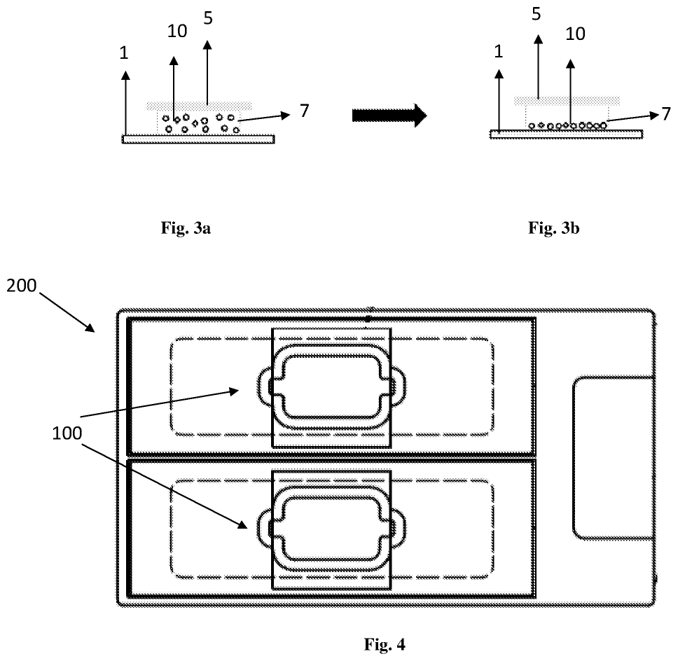

In the illustrative embodiment, the spacer element (7) may be positioned on the flow surface to resemble a profile including, but not limited to, rectangular profile, rounded rectangular profile, in order to define the chamber (2) with a length and width. However, the chamber (2) may be formed with other profiles such as, but not limited to, square profile, rhombic profile, and the like, as per requirement. Additionally, the spacer element (7) and in-turn the chamber (2) may be defined with a predefined height. In an embodiment, the predefined height is at least two times the height of a group of large size particles in the plurality of particles (10) of the biological fluid. In an embodiment, the biological fluid may be urine having viscosity that may range from 0.5 cP to 2 cP. For example, urine may include plurality of particles (10) such as but not limited to bacteria, RBC, WBC, crystals, etc., which may have the particle size which may be in the range of 1 μm to 75 μm. Further, the predefined height of the chamber (2) may range from about 150 μm to 400 μm. The predefined height of the chamber (2) enables the plurality of particles (10) of the biological fluid (that is urine) received within the chamber (2) to settle and form a monolayer due to gravity sedimentation over the predefined time [as seen in FIGS. 3a and 3b]. Further, the coverslip (5) may be positioned on the spacer element (7) such that, at least a portion of the chamber (2) may be concealed or covered by the coverslip (5) from a top region of the chamber (2). For example, the coverslip (5) may be positioned to cover the chamber (2) about the length and the width, to restrain transverse flow of the biological fluid in the chamber (2). Additionally, the spacer element (7) may be suitably configured to define an inlet section (3a) at one end (4a) of the chamber (2). The inlet section (3a) of the chamber (2) may be beyond the coverslip (5), to allow the introduction of the biological fluid into the chamber (2). It may be noted that, the one end (4a) of the chamber (2) may be along a side about the width of the chamber (2), through which a portion may be extended to define the inlet section (3a). That is, the inlet section (3a) may be defined on a width-wise side of the chamber (2) that may extend beyond the coverslip (5) and may expose the inlet section (3a) to the surroundings.

Further, the spacer element (7) may be configured to define an outlet section (3b) at another end (4b) opposite to the one end (4a) of the chamber (2). That is, the outlet section (3b) may be defined on a width-wise side opposite to the side of the chamber (2) having the inlet section (3a). The outlet section (3b) may be defined to extend beyond the concealment of the coverslip (5) and, extent of such extension in the outlet section (3b) may be based on characteristics of the biological fluid to be accommodated in the chamber (2) for analysis. It may be noted that the outlet section (3b) may be defined as a parameter that may generate and regulate the flow of the biological fluid into the chamber (2), upon introduction through the inlet section (3a). The inlet section (3a) and the outlet section (3b) of the chamber (2) may be exposed to the surroundings so that pressure within the chamber (2) may be maintained at atmospheric pressure. Further, the outlet section (3b) of the chamber (2) may be defined with a tail portion proximal to the other end (4b) of the chamber (2), which may be exposed to the surroundings for maintaining the pressure within the chamber (2) at the atmospheric pressure.

The biological fluid may be introduced into the chamber (2) through the inlet section (3a) by a conveyor means such as, but not limited to, a pipette, capillary tube, dropper and any other conveyor means which may be employable for introduction of the biological fluid into the chamber (2) without inducing pressure on the biological fluid as generally performed by pumps. In an embodiment, volume of the biological fluid introduced into the chamber (2) may be in the range of about 0.06 ml to about 0.8 ml, and preferably less than 0.5 ml. The biological fluid at the inlet section (3a) may constitute a high-pressure region, while the pressure within the chamber (2) may be at the atmospheric pressure. Such difference in pressure at the inlet section (3a) and inside of the chamber (2) may enable movement of the biological fluid into the chamber (2) as a result of capillary action [that is, by virtue of capillary force (F) acting between the biological fluid, the base plate (1) and the coverslip (5)]. In an embodiment, due to movement of the biological fluid under the capillary action, atmospheric air present in the chamber (2) may be vented through the outlet section (3b), while the biological fluid may be uniformly distributed across the chamber (2). Referring now to FIGS. 3a and 3b, the plurality of particles (10) of the biological fluid when introduced within the chamber (2) may be enriched about the predefined height of the chamber (2), under action and/or influence of gravity over a predefined time. For example, the plurality of particles (10) of the biological fluid may be scattered along the predefined height of the chamber (2) and the predefined height enables the scattered plurality of particles (10) to settle on the base plate (1) over the predefined time, to enrich the biological fluid. This leads to collection of the biological fluid within the chamber (2) and may form a monolayer of the plurality of particles (10) for analysis of the biological fluid through the microscope. In an embodiment, the plurality of particles (10) of the biological fluid within the chamber (2) may be subjected to gravity sedimentation such that the plurality of particles (10) settles and gets selectively stratified to form a monolayer about the predefined height of the chamber (2) over the predefined time. For example, urine may be introduced into the chamber which may have low viscosity which may be in the range of 1 cP to 2 cP. Urine due to the low viscosity may fill the chamber (2) and may undergo gravity sedimentation, whereas any other fluid having high viscosity may not fill the volume of the chamber (2) and may not undergo gravity sedimentation. In an embodiment, the predefined time required for gravity sedimentation may be in the range of about 1 min to about 15 min.

In addition, as the outlet section (3b) of the chamber (2) may be exposed to the surroundings, the atmospheric pressure acting at the outlet section (3b) may resist overflow of the biological fluid in the chamber (2). In order to restrain overflow of the biological fluid, length of the outlet section (3b) may be suitably defined to form the tail portion, so as to exert equivalent atmospheric pressure and balance the flow of the biological fluid in the chamber (2). This way, the biological fluid may be uniformly distributed in the chamber (2) and, an optimal packing density of the plurality of particles (10) or the cells in the biological fluid may be attained within the length, the width and the predefined height of the chamber (2) for analysis. Also, such configuration of the chamber (2), the inlet section (3a) and the outlet section (3b) may assist the biological fluid to occupy substantially complete volume in the chamber (2). The term “substantially” may refer to a proportion by vol. of at least 96% of vol. of the chamber (2) being occupied by the biological fluid, while substantial portion of remaining vol. of the chamber (2) may be filled with at least one other fluid including, but not limited to, staining reagent, buffer, highlighter, indicator, and any other fluid that may not lead to air bubble formation in the chamber (2). In an embodiment, the biological fluid (that is urine) may be accommodated along the predefined height of the chamber (2) which may enable the plurality of particles (10) in the biological fluid to settle on the base plate (1) and facilitate easy observation of the required plurality of particles (10) which are settled and the unwanted particles of the plurality of particles (10) may remain suspended in the biological fluid [as seen in FIG. 3b].

In an embodiment, for uniform distribution of the plurality of particles (10) in the biological fluid, a point of balance may be required to be maintained along the length of the chamber (2), in order to balance the capillary action of the biological fluid and the atmospheric pressure acting on the chamber (2). The point of balance may be a point that may be mathematically calculated to determine the location of the outlet section (3b) along the length of the chamber (2), for balancing the atmospheric pressure and the capillary action acting on the biological fluid. When the sample flows inside the chamber (2) by capillary action, the plurality of particles (10) present in the sample exert a drag force, however, the drag of the biological fluid, for example, urine is less due to low viscosity and surface tension, which may lead to uniform filling of the chamber (2). It should be noted that, fluids of high viscosity may not effectively fill the chamber (2) and may not facilitate gravity sedimentation even though the chamber (2) may be defined with the predefined height.

Due to the action of the drag force on the plurality of particles (10) of the biological fluid, the length of the tail portion may be required to be varied in accordance with the biological fluid being received by the chamber (2).

In an embodiment, the length of the tail portion may be varied between 0% to 200% of the width of the chamber (2) for the biological fluid. Additionally, a coating surface may be applied on the base plate (1) and the coverslip (5), which may be configured to stain the biological fluid to aid in further processing of the biological fluid accommodated within the chamber (2). In another embodiment, the coating surface may be employed to suitably vary the angle of contact of the biological fluid. The coating surface may be configured to vary a contact angle of the biological fluid with the base plate (1) and the coverslip (5), in order to suitably vary the length of the tail portion in the chamber (2). In an embodiment, the coating layer may be a dye or at least one of P100 coating solution, Pluronic solution, Polyvinyl alcohol and the like. Due to application of the coating surface on the base plate (1) and the coverslip (5), the contact angle of the biological fluid may range from about 10° to about 40°. This way, the tail portion may enable the biological fluid to fill and distribute equally about a predominant volume of the chamber (2) so that a scan region for the microscope may be enhanced to analyze the biological fluid. In an embodiment, the scanning region may be defined with a dimension in accordance with a given dimension of the chamber (2).

Referring now to FIGS. 3a and 3b, the chamber (2) may be configured to produce a mono-layer of the plurality of particles (10) or smear the plurality of particles (10) in the biological fluid, under the capillary action, gravity sedimentation and the atmospheric pressure acting on the plurality of particles (10) of the biological fluid for spreading between the surfaces of the chamber (2). That is, the plurality of particles (10) of the biological fluid may spread between the top surface of the base plate and along the predefined height of the chamber (2). Further, the biological fluid may be stored within the chamber (2) for the predefined time. The biological fluid introduced within the chamber (2) may include the plurality of particles (10) which may be scattered throughout the volume of the chamber (2) and along the predefined height. The predefined height of the chamber (2) enables the plurality of particles (10), to settle down under gravity, due to gravity sedimentation and form the monolayer of the plurality of particles (10) [as seen in FIG. 3b] during the predefined time. This way, accurate and reliable counting of the plurality of particles (10) of the biological fluid in the scan region may be possible. Further, the monolayer may include a focus region which may be defined by a combination of the group of moderate size particles, the group of lower size particles and the group of large size particles in the plurality of particles (10). Furthermore, the monolayer may include a sparse region which may be defined by the group of the large size particles in the plurality of particles (10). and the bottom surface of the coverslip (5) and along the side walls defined by the chamber (2) [as seen in FIG. 3a], to produce the mono-layer [as seen in FIG. 3b] of the biological fluid for scanning through the microscope. In an operational embodiment, upon introducing the biological fluid, due to the capillary action, the biological fluid takes up the volume of the chamber (2) [as seen in FIG. 3a]. In an embodiment, the monolayer which may be defined by the plurality of particles (10) of the biological fluid in the chamber (2) may include a clumber region which may be defined by the group of lower size particles in the plurality of particles (10). In an embodiment, the clumber region may include densely packed field of view, while sparse region may include loosely packed field of view within minimal particles of the biological fluid for analysis. Further, the focus region may include a combination of the plurality of particles stratified at different levels about the predefined height of the chamber (2), thereby providing optimal field of view for analysis under the microscope. In the focus region, stratified layers of the plurality of particles (10) may include gas particles there between under action of gravity and due to capillary action, which allows various analysis processes including, but not limited to, cell count, cell morphology, and the like to be performed under the microscope. The regions may be defined by the density of the plurality of particles (10) present and may be formed due to the flow of the biological fluid within the chamber (2) during the capillary action. In an embodiment, the stratification of the plurality of particles (10) may be formed due to velocity of each of the plurality of particles (10) during insertion of the biological fluid into the chamber (2) and also due to the capillary action. Each of the plurality of particles (10) may travel at about the predefined height of the chamber at different velocity than the other particles of the plurality of particles (10) based on particle weight and particle size, which settle over the predefined time.

Referring now to FIG. 4 which illustrates a microfluidic cartridge assembly (200). The microfluidic cartridge assembly (200) may be employable to perform a microscopic analysis and a chemical/bio-chemical analysis of the biological fluid. In the illustrative embodiment, the microfluidic cartridge assembly (200) includes a plurality of microfluidic cartridges (100), each being physically separated from one another. Each of the plurality of microfluidic cartridges (100) in the microfluidic cartridge assembly (200) may be configured to receive and accommodate the biological fluid. Further, at least one microfluidic cartridge (100) of the plurality of microfluidic cartridges (100) is configured to receive a stained biological fluid, in order to analyze aspects such as, but not limited to, cytology for differential cell counts in the biological fluid. Also, at least one of the plurality of microfluidic cartridges (100) in the microfluidic cartridge assembly (200) may be configured to receive an un-stained biological fluid to analyze aspects including, but not limited to, total cell count in the biological fluid. It may be noted that, the stained biological fluid may be attained by adding and/or mixing a predetermined staining agent with the biological fluid or by adding the coating surface, while the un-stained biological fluid may simply be the biological fluid as received and/or extracted from the subject.

In an embodiment, the predefined height of the chamber (2) in each of the plurality of microfluidic cartridges (100) may either be uniform or may be varied in accordance with the staining condition of the biological fluid.

In an embodiment, the microfluidic cartridge assembly (200) assists in performing analysis of cell count, cell motility as well as cell cytology of the biological fluid.

In an embodiment, preparation of the biological fluid may require minimal or no operator intervention.

In an embodiment, minimal quantity of the biological fluid may be required to occupy the volume of the chamber (2).

In an embodiment, the microfluidic cartridge (100) enables formation of monolayer and uniform distribution of the plurality of particles in the biological fluid without forming empty regions in the chamber.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### REFERRAL NUMERALS

| Reference Number | Description |
|---|---|
| 100 | Microfluidic cartridge assembly |
| 200 | Microfluidic cartridge |
| | Base plate |
| 2 | Chamber |
| 3a | Inlet section |
| 3b | Outlet section |
| 4a | One end |
| 4b | Another end |
| 5 | Coverslip |
| 7 | Spacer element |

We claim:

1. A microfluidic cartridge (100) for enriching a biological fluid of low viscosity, the cartridge (100) comprising:
a base plate (1) defining a flow surface;
a coverslip (5) positioned above the base plate (1), to define a chamber (2) on the flow surface of the base plate (1) for receiving the biological fluid containing a plurality of particles (10), the coverslip (5) is configured to conceal at least a portion of the chamber (2), wherein the chamber (2) is defined with a predefined height;
an inlet section (3a) defined at one end (4a) of the chamber (2) for introducing the biological fluid; and
an outlet section (3b) defined at another end (4b) opposite to the one end (4a) of the chamber (2) and extending beyond the coverslip (5), to draw the biological fluid under capillary action;
characterized in that, the predefined height of the chamber (2) is at least two times the height of a group of large size particles in the plurality of particles (10) in the biological fluid, wherein the plurality of particles (10) of the biological fluid is enriched about the predefined height of the chamber (2), under gravity sedimentation over a predefined time to form a monolayer.

2. The cartridge (100) as claimed in claim 1, wherein the biological fluid is urine.

3. The cartridge (100) as claimed in claim 1, wherein the predefined height of the chamber (2) ranges from about 150 μm to 400 μm.

4. The cartridge (100) as claimed in claim 1, wherein the monolayer defined by the plurality of particles (10) of the biological fluid in the chamber (2) comprises:
a clumber region defined by a group of lower size particles in the plurality of particles (10);
a focus region defined by combination of a group of moderate size particles, the group of lower size particles, and a group of large size particles; and
a sparse region defined by the group of the large size particles.

5. The cartridge (100) as claimed in claim 1, comprises a spacer element (7), positioned between the base plate (1) and the coverslip (5), wherein the spacer element (7) defines the chamber (2), the inlet section (3a) and the outlet section (3b).

6. The cartridge (100) as claimed in claim 1, wherein the predefined time ranges from about 1 min to 15 mins.

7. The cartridge (100) as claimed in claim 1, wherein volume of the biological fluid introduced into the chamber (2) ranges from 0.06 ml to 0.8 ml.

8. The cartridge (100) as claimed in claim 1, wherein viscosity of the biological fluid ranges from 0.5 cP to 2 cP.

9. The cartridge (100) as claimed in claim 1, comprises a coating surface applied on the base plate (1) and the coverslip (5), wherein the coating surface is configured to stain the biological fluid.
